(19) United States
(12) Patent Application Publication
(10) Pub. No.: US 2005/0175113 A1
(43) Pub. Date: Aug. 11, 2005

(54) Digital signal demodulation of an OFDM signal with error correction

(76) Inventor: Hideo Okuyama, Tokyo (JP)

Correspondence Address: FRANCIS I. GRAY;TEKTRONIX, INC., MS 50-LAW, P.O. BOX 500, BEAVERTON, OR, 97077, US

(21) Appl. No.: 11/014,533

(22) Filed: Dec. 15, 2004

(30) Foreign Application Priority Data
Dec. 16, 2003 (JP) 2003-417460

(51) Int. Cl. H04K 1/10

(52) U.S. Cl. 375/260; 375/348

(57) ABSTRACT

A digital signal demodulator digitizes an OFDM signal at a sampling frequency from a sampling oscillator to produce a digital OFDM signal. The digital OFDM signal is converted into I and Q components using a carrier frequency from a carrier oscillator. The IQ components are transformed into digital complex symbols, and pilot signals are extracted from the complex symbols. A processor calculates an inter-symbol difference of phase differences between pilot signals to control the sampling oscillator to correct the sampling frequency; calculates an inter-symbol difference for one of the pilot signals to control the carrier oscillator to correct the carrier frequency; and calculates a phase angle for one of the subcarriers at a frequency in the middle of the plurality of subcarriers for the OFDM signal to control the carrier oscillator to correct the carrier frequency phase.

### BACKGROUND OF THE INVENTION

The present invention relates to communication systems using OFDM (Orthogonal Frequency Division Multiplexing) modulation, such as ISDB-T (Integrated Services Digital Broadcasting for Terrestrial), wireless Local Area Network (LAN), etc., and more particularly to digital signal demodulation of such signals with error correction for carrier frequency and phase errors and sampling frequency errors.

ISDB-T and wireless LAN systems have adopted OFDM modulation for transmission of information. In communication systems using OFDM, a transmitter maps an input signal onto a set of orthogonal subcarriers, i.e., the orthogonal basis of a discrete Fourier transform (DFT). The use of orthogonal subcarriers allows the subcarriers' spectra to overlap, thus increasing spectral efficiency. The peak of one subcarrier occurs at the zero crossings of the adjacent subcarriers in the spectrum for an OFDM signal. In practice a combination of a fast Fourier transform (FFT) and an inverse fast Fourier transform (iFFT), which are mathematically equivalent versions of the DFT and an inverse discrete Fourier transform (iDFT), are used as being more efficient to implement. The OFDM system treats source symbols (collections of bits), i.e., like the quadrature phase shift keying (QPSK) or quadrature amplitude modulation (QAM) symbols of a single carrier system, as if they are in the frequency domain. The iFFT function brings them into the time domain and takes in N symbols at a time, where N is the number of subcarriers and each has a symbol period of T seconds. Since the input symbols are complex, the value of the symbol determines the amplitude and phase of the sinusoid for that subcarrier. The iFFT output is the summation of all N sinusoids, i.e., the iFFT function provides a simple way to modulate data onto N orthogonal subcarriers. The block of N output samples from the iFFT make up a single OFDM symbol of length NT. The summed iFFT output is converted into a radio frequency (RF) signal for transmission to a receiver. The receiver converts the radio frequency signal into an intermediate frequency to recover the OFDM signal, and the FFT function processes the received signal to bring it back to the frequency domain, i.e., to reproduce ideally the originally transmitted symbols. The symbols, when plotted in a complex plane, form a quadrature constellation display, such as 16-QAM. For example, IEEE 802.11a uses 52 subcarriers of which 48 subcarriers are for data and 4 subcarriers are for pilot signals, and each subcarrier is modulated by BPSK (Binary Phase Shift Keying), QPSK, 16QAM or 64QAM. The subcarriers for the pilot signals have known frequencies and phases.

If the receiver has sampling frequency errors, carrier frequency errors or carrier phase errors with respect to the transmitter due to the OFDM demodulation, it may not recover the originally transmitted symbols correctly. Therefore it is necessary to correct these errors. A method is known that calculates and corrects errors based on a correlation between a guard interval and a latter part of an effective symbol period. Japanese Patent Publication No. 2000-196560 discloses how to detect carrier frequency errors. The carrier frequency error causes interference of subcarriers such that the power of each subcarrier changes. The carrier frequency error is detected by referring to a power difference for each subcarrier. Ideal output sequences of a DFT (Discrete Fourier Transform) are calculated previously for given types of carrier frequency errors and a correlation between the DFT output sequence calculated from the received signal and the ideal ones is used to find the carrier frequency errors.

What is desired is a new technique for correcting sampling frequency errors and carrier frequency and phase errors during the digital signal demodulation of an OFDM signal.

### BRIEF SUMMARY OF THE INVENTION

Accordingly the present invention provides digital signal demodulation of an input signal from an OFDM modulated signal, the input signal being coded to a complex symbol signal sequence with pilot signals added for modulating multiple subcarriers. The received OFDM signal is digitized at a predetermined sampling frequency by an analog-to-digital converter to produce a digital OFDM signal. A complex multiplier converts the digital OFDM signal into I and Q components according to a carrier frequency from a carrier frequency oscillator. An FFT processor transforms the I and Q components into complex symbols. A pilot signal extractor extracts the pilot signals from the complex symbols. A processor evaluates an inter-symbol difference of phase differences between the extracted pilot signals. The processor provides control signals to correct the sampling frequency according to the inter-symbol difference. To evaluate the inter-symbol difference, the processor may calculate a plurality of inter-symbol differences and smooth them by taking an average of them or by applying a least-squares method to them. The processor also may calculate an inter-symbol difference of the phase angles of one of the pilot signals, and control the carrier frequency oscillator to correct the carrier frequency according to the inter-symbol difference of the phase angles. The processor further may evaluate a phase angle of a center one of the subcarriers by calculating the phase angle of the subcarrier by the mean-squares method to correct the phase of the carrier frequency from the carrier frequency oscillator.

The objects, advantages and other novel features of the present invention are apparent from the following detailed description when read in conjunction with the appended claims and attached drawing.

### BRIEF DESCRIPTION OF THE SEVERAL VIEWS OF THE DRAWING

FIG. 1 is a block diagram view of a digital OFDM demodulator according to the present invention.

FIG. 2 is a timing chart view showing relationships for symbol periods between sent and received signals when there are sampling frequency errors.

### DETAILED DESCRIPTION OF THE INVENTION

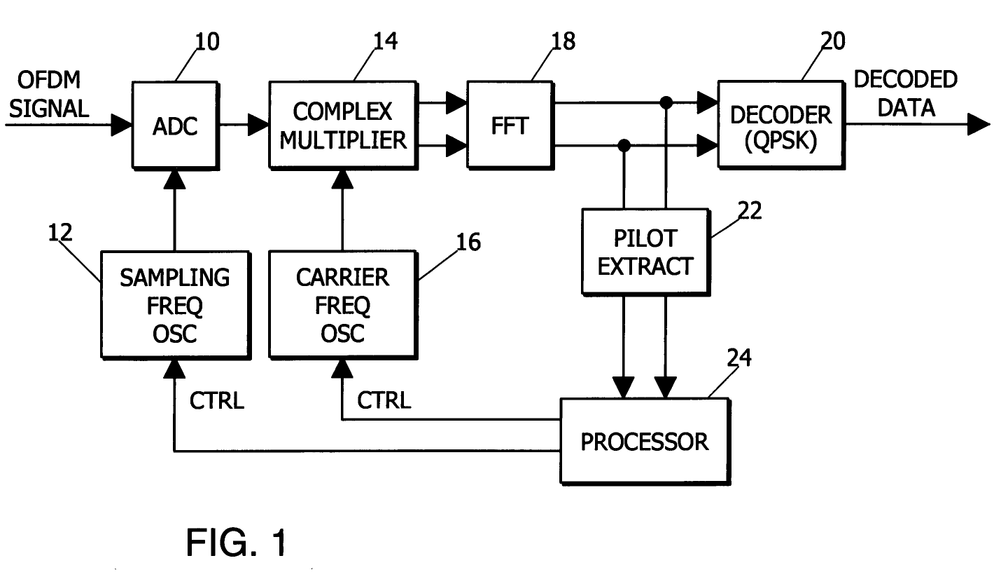

Referring now to FIG. 1, an analog-to-digital converter (ADC) 10 receives an OFDM signal and digitizes it according to a sampling frequency output from a sampling frequency oscillator 12 to produce a digital OFDM signal. The OFDM signal may be received as an RF frequency signal and converted to an IF frequency signal that includes pilot signals prior to digitizing. A complex multiplier 14 receives a carrier frequency signal from a carrier frequency oscillator 16 to convert the digital OFDM signal into I (real) and Q (imaginary) components. An FFT processor 18 transforms the I and Q components into complex symbol signals. A decoder 20 decodes the complex symbol signals according to the digital modulation format used in the transmitter, such as QPSK, to recover original symbols transmitted by the OFDM signal. The complex symbol signals are also provided to a pilot signal extractor 22 to extract the pilot signals. The pilot signals are input to a processor 24 to generate control signals for the sampling frequency oscillator 12 and the carrier frequency oscillator 16. Although not shown, the processor 24 may have control means and peripherals including a microprocessor, hard disk drive, mouse, keyboard etc. A control program may be stored in a storage means such as the hard disk drive.

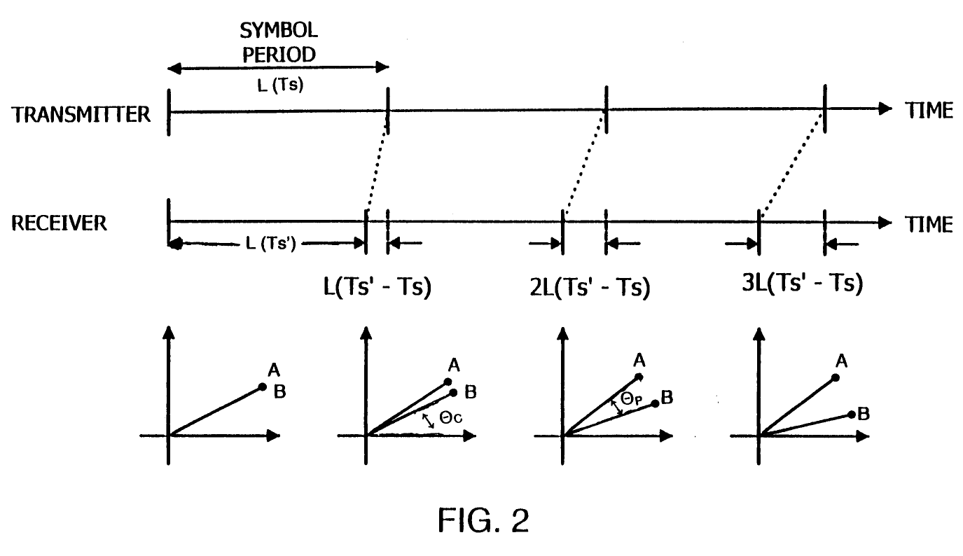

FIG. 2 shows, as an example, the sampling frequency of the receiver being slightly higher than that of the transmitter so that a symbol period LTs' at the receiver is shorter than the symbol period LTs at the transmitter. Therefore, a difference between the symbol periods (inter-symbol difference) gets larger—L(Ts′-Ts), 2L(Ts′-Ts), 3L(Ts′-Ts) . . . —as the symbol period repeats. In this example, a phase difference θp between different pilot signals A and B gets larger as the symbol period advances, as shown by the rotation of B with respect to A. Here L is the number of samples during one symbol period including a guard interval, and Ts and Ts' are transmitter and receiver sampling periods respectively. An inter-symbol difference Δθp of phase between pilot signals A and B included in time adjacent symbols is denoted by the following equation 1:

$${Δθ}_{p} = L ( {Ts}^{′} - Ts ) \frac{1}{Ts} \frac{2 π}{n} \qquad ( 1 )$$

Ts: Sampling period in transmitter
Ts′: Sampling period in receiver
Ts-Ts′: Sampling period error
n: FFT length used for OFDM modulation (Sampling number during one symbol period without a guard interval)
L: Sampling number during one symbol period including a guard interval

Further, if an error of symbol period difference ΔT is within +/−Ts′, θp is determined by the following equation 2:

$${θ}_{p} = \frac{Δ T}{{Ts}^{′}} \frac{2 π}{n} \qquad ( 2 )$$

θₚ represents sample timing error of an OFDM symbol. Δθₚ is the average of the differences of the phase differences between symbols or the LSM of the phase differences. Δθₚ (Equation 1) represents the sampling frequency error between transmitter and receiver.

The processor 24 receives the pilot signals from the pilot signal extractor 22 to calculate the phase difference θp between the pilot signals for the different subcarriers and further calculates the inter-symbol difference Δθp, or the difference of the phase differences θp between one symbol and the next. To evaluate the inter-symbol difference, a plurality of inter-symbol differences of the phase differences may be calculated, and an average of the inter-symbol differences or a least-squares method may be used for smoothing. These methods reduce noise and frequency characteristic distortions. The phase difference θp may be calculated by calculating a phase angle θc of the pilot signal A from the IQ components for the complex symbols of the pilot signal A using an arctangent function, by calculating a phase angle θc of the pilot signal B, and then obtaining the difference between them: θc(B)−θc(A)=θp. Then normalization is done. Normalization means to evaluate a phase difference per subcarrier frequency difference. Since the pilot signal subcarriers are located at intervals among all the subcarriers that make up the OFDM signal, a phase difference between pilot signals corresponds to the sum of phase differences between adjacent subcarriers between the pilot signals.

The processor 24 calculates the sampling frequency error “Ts′-Ts” and ΔT, ΔT being approximately equal to L(Ts′-Ts), using the equations 1 and 2 and the measured phase differences, which are in turn used to control the sampling frequency oscillator 12 to correct the sampling frequency and symbol timing so that the measured values equal zero. L(Ts′-Ts) is the sampling period error integrated for a symbol period and ΔT is a symbol timing error between symbol timing at the transmitter and receiver, i.e., ΔT indicates whether a symbol of a received signal is sampled at the beginning.

Next, the processor 24 calculates the phase angle Oc of one of the pilot signals from the IQ components of the complex symbols using the arctangent function. Then it calculates a difference between the phase angles θc of one symbol and the next symbol, i.e., an inter-symbol difference Δθc of the phase angles Ec for the single pilot signal. If the carrier frequency error is Δfc, the relationship of the inter-symbol difference Δθc of the phase angles θc may be denoted by the following equation 3:

$$Δ {f}_{c} = \frac{Δ {θ}_{c}}{{LTs}^{′}} \qquad ( 3 )$$

Ts′: Sampling period receiver (estimated sampling period at transmitter)
L: Sample number of one symbol period including a guard interval

The inter-symbol difference Δθc of phase angle θc of the pilot signal may be evaluated by calculating inter-symbol differences Δθc for a plurality of symbols and averaging them or applying least-squares method to them for smoothing, which reduces effects due to noise or frequency characteristic distortions. The processor 24 controls the carrier frequency oscillator 16 to correct the carrier frequency error by using the carrier frequency error Δfc evaluated by equation 3.

The carrier frequency phase correction may be done after the FFT process, but that increases the calculation overhead. Therefore, a rough correction of the carrier frequency phase is done before the FFT process to reduce the calculation overhead for the phase error correction after the FFT process.

The processor 24 evaluates approximate polynomials of phases of pilot subcarriers relative to the subcarriers and then evaluates an estimated phase θc for a specific subcarrier from the polynomials, such as by using a least-squares method. Preferably the specific subcarrier has a middle frequency among the subcarriers because it shows average phase error among them. The processor 24 controls the carrier frequency oscillator 16 to correct the phase of the carrier frequency signal provided to the complex multiplier 14 by −θc. This moves the phase angles of the other subcarriers closer to zero as well as the subcarrier used for calculating the phase angle θc, and reduces correction calculation overhead after the FFT process.

Thus the present invention provides a digital signal demodulator for an OFDM signal that corrects carrier frequency error, sampling frequency error, and phase error of the carrier frequency so that it demodulates digital data more accurately.

1. A digital signal demodulator for an OFDM signal comprising:
means for digitizing the OFDM signal at a given sampling frequency to produce a digital OFDM signal having complex components;
means for transforming the complex components to complex symbols;
means for extracting pilot signals from the complex symbols;
means for calculating an inter-symbol difference of phase differences between the pilot signals; and
means for correcting the given sampling frequency according to the inter-symbol difference.

2. The digital signal demodulator as recited in claim 1 wherein the calculating means comprises:
means for determining a plurality of inter-symbol differences; and
means for smoothing the plurality of inter-symbol differences to obtain the inter-symbol difference.

3. A digital signal demodulator for an OFDM signal comprising:
means for digitizing the OFDM signal at a given sampling frequency to produce a digital OFDM signal;
means for converting the digital OFDM signal to complex components using a carrier frequency;
means for transforming the complex components into complex symbols;
means for extracting pilot signals from the complex symbols in the frequency domain;
means for calculating an inter-symbol difference of phase angles for one of the pilot signals; and
means for correcting the carrier frequency according to the inter-symbol difference.

4. A digital signal demodulator for an OFDM signal comprising:
means for digitizing the OFDM signal at a given sampling frequency to produce a digital OFDM signal;
means for converting the digital OFDM signal to complex components using a carrier frequency;
means for transforming the complex components to complex symbols;
means for extracting pilot signals from the complex symbols;
means for calculating a phase angle of one of a plurality of subcarriers used by the OFDM signal using phase angles of the pilot signals; and
means for correcting a phase of the carrier frequency according to the phase angle.

5. The digital signal demodulator as recited in claim 4 wherein the one subcarrier comprises a frequency selected from approximately a center of the plurality of subcarriers.
